(19) United States
(12) Patent Application Publication
(10) Pub. No.: US 2024/0332480 A1
(43) Pub. Date: Oct. 3, 2024

(54) METAL OXIDE LITHIOPHILIC COATING ON STAINLESS STEEL CURRENT COLLECTOR

(71) Applicant: GM GLOBAL TECHNOLOGY OPERATIONS LLC, Detroit, MI (US)

(72) Inventors: Sayed Youssef Sayed NAGY, Troy, MI (US); Caleb Reese, Ferndale, MI (US); Shaomao Xu, Sterling Heights, MI (US); Diptak Bhattacharya, Royal Oak, MI (US)

(21) Appl. No.: 18/130,161

(22) Filed: Apr. 3, 2023

(51) Int. Cl. H01M 4/04

(52) U.S. Cl. CPC H01M 4/0404; H01M 4/0419; H01M 4/0426; H01M 4/045; H01M 4/0471; H01M 4/0483

(57) ABSTRACT

A method for fabricating an anode electrode includes providing a stainless steel current collector, forming a metal oxide layer on the stainless steel current collector, and pouring molten lithium over the metal oxide layer of the stainless steel current collector to create a lithium metal layer on the metal oxide layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a metal oxide lithiophilic coating on a stainless steel current collector.

Electric vehicles such as battery electric vehicles and hybrid vehicles include a battery pack including one or more battery modules each including one or more battery cells. The battery cells include anode electrodes, cathode electrodes and separators are arranged in a predetermined sequence in an enclosure. The anode electrodes typically include anode active material arranged on opposite sides of an anode current collector. The cathode electrodes typically include cathode active material arranged on opposite sides of a cathode current collector.

### SUMMARY

A method for fabricating an anode electrode includes providing a stainless steel current collector; forming a metal oxide layer on the stainless steel current collector; and pouring molten lithium over the metal oxide layer of the stainless steel current collector to create a lithium metal layer on the metal oxide layer.

In other features, the stainless steel current collector is selected from a group consisting of mesh, foil, and expanded metal.

In other features, forming the metal oxide layer comprises spin-coating a metal nitrate salt onto the stainless steel current collector and heating the stainless steel current collector to a decomposition temperature of the metal nitrate salt. The metal nitrate salt is selected from a group consisting of aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃).

In other features, forming the metal oxide layer comprises spraying a metal nitrate salt onto the stainless steel current collector; and heating the stainless steel current collector to a decomposition temperature of the metal nitrate salt. The metal nitrate salt is selected from a group consisting of aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃).

In other features, forming the metal oxide layer comprises electroplating the stainless steel current collector with the metal oxide layer.

In other features, forming the metal oxide layer comprises depositing the metal oxide layer in a vacuum deposition chamber.

A method for fabricating a battery cell includes fabricating an anode electrode by providing a stainless steel current collector selected from a group consisting of mesh, foil, and expanded metal; forming a metal oxide layer on the stainless steel current collector; and pouring molten lithium over the metal oxide layer of the stainless steel current collector to create a lithium metal layer on the metal oxide layer. Arranging a plurality of anode electrode, a plurality of cathode electrodes, and a plurality of separators in a predetermined sequence in an enclosure of a battery cell.

In other features, forming the metal oxide layer comprises spin-coating a metal nitrate salt onto the stainless steel current collector; and heating the stainless steel current collector to a decomposition temperature of the metal nitrate salt. The metal nitrate salt is selected from a group consisting of aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃).

In other features, forming the metal oxide layer comprises spraying a metal nitrate salt onto the stainless steel current collector; and heating the stainless steel current collector to a decomposition temperature of the metal nitrate salt. The metal nitrate salt is selected from a group consisting of aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃).

In other features, forming the metal oxide layer comprises electroplating the stainless steel current collector with the metal oxide layer.

In other features, forming the metal oxide layer comprises depositing the metal oxide layer in a vacuum deposition chamber.

A method for fabricating a battery cell includes forming an anode electrode by providing a stainless steel current collector selected from a group consisting of mesh, foil, and expanded metal; forming a metal oxide layer on the stainless steel current collector by one of spin-coating and spraying a metal nitrate salt onto the stainless steel current collector. The metal nitrate salt is selected from a group consisting of aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃). The method includes heating the stainless steel current collector to a decomposition temperature of the metal nitrate salt. Pouring molten lithium over the metal oxide layer of the stainless steel current collector to create a lithium metal layer on the metal oxide layer. The method includes arranging a plurality of the anode electrode, a plurality of cathode electrodes, and separators in a predetermined sequence in an enclosure of a battery cell.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a battery cell including anode electrodes with stainless steel current collectors with a metal oxide layer and a lithium metal layer, cathode electrodes, and separators according to the present disclosure;

FIG. 2 is a side cross-sectional view illustrating an example of an anode electrode with a stainless steel current collector, a metal oxide layer, and a lithium metal layer according to the present disclosure; and

FIG. 3 is a flowchart of an example of a method for fabricating an anode electrode and a battery cell including the anode electrode according to the present disclosure.

In the drawings, reference numbers may be reused to identify similar and/or identical elements.

### DETAILED DESCRIPTION

The present disclosure relates to stainless steel current collectors that are coated with a metal oxide layer. The stainless steel current collectors with the metal oxide layers are coated with molten lithium to form anode electrodes. Further processing of the anode electrodes is performed such as forming external tabs and/or other processing. The anode electrodes, cathode electrodes, and separators are arranged in a predetermined sequence in an enclosure to form a battery cell. While the battery cells are described in the context of electric vehicles, the battery cells can be used in stationary or other applications.

Stainless steel does not adhere to molten lithium due to a surface reaction of a native oxide layer on the stainless steel with molten lithium and the formation of unfavored lithium-based oxides. For example, chromium (Cr) and chromium oxide (Cr₂O₃) spontaneously react with lithium to form LiMOₓ (where M is a metal such as Cr, Ni, or Fe). Removal of Cr₂O₃ on the stainless steel needs to be done in an inert atmosphere (e.g., an Ar-filled glovebox) to prevent spontaneous reformation of the Cr₂O₃, which increases production cost.

The present disclosure relates to a method for coating a surface of a stainless steel current collector with a metal oxide layer having lithiophilic properties. The metal oxide layers improve adhesion of the molten lithium onto the stainless steel current collectors. The improved adhesion is a result of a conversion reaction between the metal oxide and molten lithium metal (Li+MO (M=metal)→Li₂O+LiM). Examples of metal oxides include aluminum oxide (Al₂O₃), indium oxide (In₂O₃), zinc oxide (ZnO), tin oxide (SnO), and bismuth oxide (Bi₂O₃).

The formation of an interfacial lithium metal alloy enables enhanced bonding of the stainless steel with the molten lithium. The surface modification of the stainless steel current collectors with the metal oxide layers can be done by spray or spin-coating and heating, electrochemical deposition, and/or vacuum-based deposition techniques.

In some examples, metal nitrate salts are spin coated or sprayed onto the stainless steel current collector are heated to cause thermal decomposition of the nitrate salts of the metal of interest (M(NO₃)₂→MO+NO₂+O₂). Example metals include aluminum (Al), indium (In), tin (Sn), zinc (Zn), and/or bismuth (Bi). The coating also enhances Li bonding in the solid state especially at warm temperatures.

The present disclosure provides a simple, low-cost approach to provide a thin lithiophilic coating on the stainless steel current collector that promotes bonding of molten lithium to the stainless steel current collector. Lithium anodes with the stainless steel current collectors and the metal oxide layer also minimize dendrite formation during cycling. The method for manufacturing the current collector is a key enabler for stainless steel current collectors, which are lower cost than anode current collectors using copper (Cu).

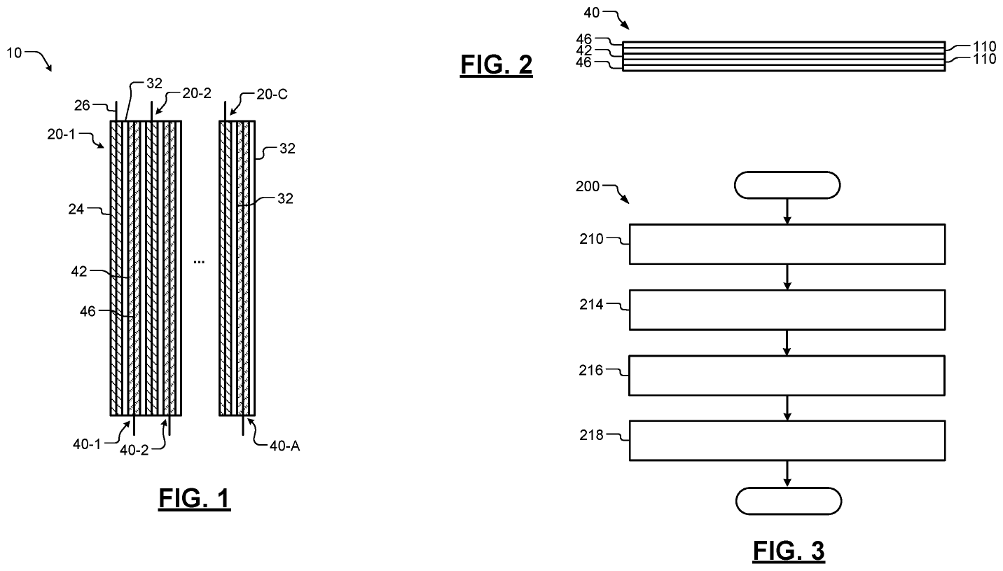

Referring now to FIG. 1, a battery cell 10 according to the present disclosure includes cathode electrodes 20-1, 20-2, . . . , and 20-C (collectively or individually cathode electrode(s) 20) including a cathode current collector 26 and a layer 24 including a cathode active material arranged one or both sides of the cathode current collector 26, where C is an integer greater than one.

The battery cell 10 includes anode electrodes 40-1, 40-2, . . . , and 40-A (collectively or individually anode electrode(s) 40) including an anode current collector 46 and a layer 42 including an anode active material one or both sides of an anode current collector 46, where A is an integer greater than one. The anode current collector 46 includes stainless steel such as foil, mesh, or expanded metal. The layer 42 includes lithium metal that is applied by pouring molten aluminum onto the anode current collector 46 that includes a metal oxide layer to promote bonding and reduce dendrite formation as will be described further below. The anode electrodes 40, the separators 32, and the cathode electrodes 20 are arranged in a predetermined sequence to form the battery cell. Typically, the anode electrodes 40 and the cathode electrodes 20 alternate and the separators 32 are arranged between the anode electrodes 40 and the cathode electrodes 20.

Referring now to FIG. 2, the anode electrode 40 is shown to include the anode current collector 46, metal oxide layer(s) 110 formed on one or both sides thereof, and the layer 42 including anode active material (e.g., lithium metal) arranged on the metal oxide layer 110.

Referring now to FIG. 3, a method 200 for manufacturing a current collector is shown. At 210, a metal oxide layer is deposited on an anode current collector comprising stainless steel foil, mesh, or expanded metal.

In a first method, a solution including a metal nitrate salt is spin coated or sprayed onto the current collector. Heating is performed to cause thermal decomposition of nitrate salts of the metal of interest (M(NO₃)₂→MO+NO₂+O₂) to form the metal oxide layer. The coating also enhances Li bonding in the solid state especially at warm temperatures. Examples of metal nitrate salts include aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃). The decomposition temperatures for solution of these metal nitrate salts of Al, In, Zn, Sn, or Bi are 150° C., 250° C., 500° C., 90° C., and 30° C., respectively.

Metal oxide thickness can be varied by modifying process parameters such as solution concentration, solution viscosity, process temperature, process time, source-substrate distance, substrate rotational speed, nozzle pressure, gun velocity, source-substrate angle, number of passes, etc.

In a second method, the metal oxide layer is electroplated onto the stainless steel current collector. For example, a 2-electrode or 3-electrode electroplating device can be used to plate the stainless steel current collector with the metal oxide layer. The thickness of the metal oxide layer can be varied by modifying process parameters such as electrolyte concentration, electrode distance, electroplating time, applied voltage, applied current, plating temperature, etc.

In a third method, the metal oxide layer is deposited onto the stainless steel current collector using vacuum deposition. Examples of vacuum deposition include electron beam evaporation (EBE) and vacuum thermal evaporation. In other examples, vacuum deposition includes chemical vapor deposition or physical vapor deposition. In other examples, atomic layer deposition, molecular beam epitaxy (MBE), metal-organic chemical vapor deposition (MOCVD), combustion chemical vapor deposition (CCVD), or arc evaporation are used. In other examples, vacuum deposition includes sputtering such as DC and/or RF sputtering and DC magnetron and reactive sputtering are used. In other examples, laser deposition techniques such as pulsed laser deposition (PLD) is used.

Metal oxide thickness can be varied by modifying process parameters such as substrate temperature, substrate distance, vacuum chamber pressure, precursor/target chemistry ratio, deposition source flux or precursor gas flow, deposition time, substrate rotational speed, laser power, DC voltage (sputtering), sputtering power, etc.

After coating the current collector with the metal oxide layer, molten lithium is poured onto the current collector at 214 and the molten lithium bonds to the metal oxide layer. At 216, additional processing of the anode electrode is performed such as forming of the external tabs or other processing. At 218, the anode electrodes, cathode electrodes and separators are arranged in a predetermined sequence in an enclosure of a battery cell.

In some examples, the adhesion of molten lithium onto stainless steel current collectors is improved due to the metal oxide coating. Stainless steel is a less expensive collector current candidate as compared to copper (Cu) for lithium metal anodes. Surface modification the stainless steel current collectors with metal oxide layers not only improves the adhesion of molten Li but also reduces dendrite formation during cycling.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for fabricating an anode electrode, comprising:
providing a stainless steel current collector;
forming a metal oxide layer on the stainless steel current collector; and
pouring molten lithium over the metal oxide layer of the stainless steel current collector to create a lithium metal layer on the metal oxide layer.

2. The method of claim 1, wherein the stainless steel current collector is selected from a group consisting of mesh, foil, and expanded metal.

3. The method of claim 1, wherein forming the metal oxide layer comprises:
spin-coating a metal nitrate salt onto the stainless steel current collector; and
heating the stainless steel current collector to a decomposition temperature of the metal nitrate salt.

4. The method of claim 3, wherein the metal nitrate salt is selected from a group consisting of aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃).

5. The method of claim 1, wherein forming the metal oxide layer comprises:
spraying a metal nitrate salt onto the stainless steel current collector; and
heating the stainless steel current collector to a decomposition temperature of the metal nitrate salt.

6. The method of claim 5, wherein the metal nitrate salt is selected from a group consisting of aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃).

7. The method of claim 1, wherein forming the metal oxide layer comprises electroplating the stainless steel current collector with the metal oxide layer.

8. The method of claim 1, wherein forming the metal oxide layer comprises depositing the metal oxide layer in a vacuum deposition chamber.

9. A method for fabricating a battery cell, comprising:
fabricating an anode electrode by:
providing a stainless steel current collector selected from a group consisting of mesh, foil, and expanded metal;
forming a metal oxide layer on the stainless steel current collector; and
pouring molten lithium over the metal oxide layer of the stainless steel current collector to create a lithium metal layer on the metal oxide layer; and
arranging a plurality of anode electrode, a plurality of cathode electrodes, and a plurality of separators in a predetermined sequence in an enclosure of a battery cell.

10. The method of claim 9, wherein forming the metal oxide layer comprises:
spin-coating a metal nitrate salt onto the stainless steel current collector; and
heating the stainless steel current collector to a decomposition temperature of the metal nitrate salt.

11. The method of claim 11, wherein the metal nitrate salt is selected from a group consisting of aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃).

12. The method of claim 10, wherein forming the metal oxide layer comprises:
spraying a metal nitrate salt onto the stainless steel current collector; and
heating the stainless steel current collector to a decomposition temperature of the metal nitrate salt.

13. The method of claim 12, wherein the metal nitrate salt is selected from a group consisting of aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃).

14. The method of claim 9, wherein forming the metal oxide layer comprises electroplating the stainless steel current collector with the metal oxide layer.

15. The method of claim 9, wherein forming the metal oxide layer comprises depositing the metal oxide layer in a vacuum deposition chamber.

16. A method for fabricating a battery cell, comprising:
forming an anode electrode by:
providing a stainless steel current collector selected from a group consisting of mesh, foil, and expanded metal;
forming a metal oxide layer on the stainless steel current collector by:
one of spin-coating and spraying a metal nitrate salt onto the stainless steel current collector,
wherein the metal nitrate salt is selected from a group consisting of aluminum nitrate (Al(NO₃)₃), indium nitrate (In(NO₃)₃), zinc nitrate (Zn(NO₃)₃), tin nitrate (Sn(NO₃)₃), and bismuth nitrate (Bi(NO₃)₃); and
heating the stainless steel current collector to a decomposition temperature of the metal nitrate salt; and
pouring molten lithium over the metal oxide layer of the stainless steel current collector to create a lithium metal layer on the metal oxide layer; and
arranging a plurality of the anode electrode, a plurality of cathode electrodes, and separators in a predetermined sequence in an enclosure of a battery cell.
